(19) United States
(12) Patent Application Publication
(10) Pub. No.: US 2017/0187179 A1
(43) Pub. Date: Jun. 29, 2017

(54) JUNCTION BOX

(71) Applicant: YAZAKI CORPORATION, Tokyo (JP)

(72) Inventors: Mitsuaki Morimoto, Shizuoka (JP); Eiichiro Oishi, Shizuoka (JP)

(21) Appl. No.: 15/383,687

(22) Filed: Dec. 19, 2016

(30) Foreign Application Priority Data
Dec. 25, 2015 (JP) 2015-253033

(51) Int. Cl. H02H 3/087; B60R 16/02; H02H 3/033; H02H 9/02; H02H 3/02; H02H 3/093

(52) U.S. Cl. CPC H02H 3/087; H02H 3/025; H02H 3/093; H02H 3/033; H02H 9/02; B60R 16/02

(57) ABSTRACT

A junction box is configured to be arranged between a DC power source and a load. The junction box includes a first mechanical relay configured to be connected to a positive terminal of the DC power source, a second mechanical relay configured to be connected to a negative terminal of the DC power source, a semiconductor relay connected in series to at least one of the first mechanical relay and the second mechanical relay, and a controller that controls driving of the first mechanical relay, the second mechanical relay and the semiconductor relay respectively. When an abnormal state occurs, the controller controls the first and second mechanical relays to turn the first and second mechanical relays off after controlling the semiconductor relay to turn the semiconductor relay off.

### CROSS REFERENCE TO RELATED APPLICATIONS

This application is based on Japanese Patent Application (No. P 2015-253033) filed on Dec. 25, 2015, the contents of which are incorporated herein by reference.

### BACKGROUND OF THE INVENTION

1. Field of the Invention

The present disclosure relates to a junction box.

2. Description of the Related Art

A high-voltage junction box using mechanical relays is installed in vehicles having a high-voltage source such as electric vehicles and hybrid vehicles. For example, JP-A-2009-189221 discloses a technique that a high-voltage fuse is provided on a path for supplying high-voltage power. While a high-voltage system is in a normal state, switching of mechanical relays to the on state or the off state is done in a situation that almost no current is flowing through the high-voltage path. Thus, a high-voltage connection operation and disconnection operation can be performed reliably using the mechanical relays.

On the other hand, configurations using a semiconductor relay instead of mechanical relays are proposed (refer to JP-A-2014-121199, for example). Since the semiconductor relay has no contact, no arc is generated even in the case of a current shutoff during conduction (e.g., at the time of occurrence of a current abnormality). Thus, an arc-induced failure can be avoided by using a semiconductor relay.

However, in the technique of JP-A-2009-189221, a power shutoff that is performed at the time of occurrence of an accident or a system abnormality is a shutoff during high-voltage conduction, resulting in generation of an arc at the mechanical relay contacts. An arc generated at each mechanical relay contact may cause its failure such as contact sticking. To prevent a contact failure of the mechanical relays, it is necessary to increase their contact maximum bearable current. However, this necessarily increases the size of the mechanical relays.

On the other hand, since JP-A-2014-121199 has no a contact, the technique of JP-A-2014-121199 is free of a contact failure that may occur in mechanical relays. Thus, unlike in mechanical relays, it is not necessary to increase the size of a circuit component to increase the contact maximum bearable current.

However, unlike in mechanical relays, semiconductor relays do not have such a circuit configuration as to establish physical isolation between a high-voltage power source and a load and may suffer a leakage of electricity or the like at the time of a shutoff due to an accident, for example. That is, the technique of JP-A-2014-121199 cannot prevent a leakage current in such a situation and hence is insufficient in safety.

### SUMMARY OF THE INVENTION

The present disclosure has been made in view of the above circumstances, and an object of the present disclosure is therefore to provide a junction box capable of increasing safety while realizing miniaturization and weight reduction.

The present disclosure provides a junction box configured to be arranged between a DC power source and a load, the junction box comprising:

a first mechanical relay configured to be connected to a positive terminal of the DC power source;

a second mechanical relay configured to be connected to a negative terminal of the DC power source;

a semiconductor relay connected in series to at least one of the first mechanical relay and the second mechanical relay; and

a controller that controls driving of the first mechanical relay, the second mechanical relay and the semiconductor relay respectively,

wherein when an abnormal state occurs, the controller controls the first and second mechanical relays to turn the first and second mechanical relays off after controlling the semiconductor relay to turn the semiconductor relay off.

In the present disclosure, the semiconductor relay is connected in series to at least one of the first and second mechanical relays and the first and second mechanical relays are turned off after turning-off of the semiconductor relay at the occurrence of an abnormal state. Thus, the semiconductor relay can limit an overcurrent and the first and second mechanical relays enable physical isolation from a high-voltage circuit. As a result, the junction box can be increased in safety while it is miniaturized and reduced in weight.

### BRIEF DESCRIPTION OF THE DRAWINGS

FIG. 1 shows an example configuration of a junction box 1 according to a first embodiment of the present disclosure.

FIG. 2 is a timing chart illustrating an example control that is performed by a controller 15 in an ordinary case in the first embodiment.

FIG. 3 shows an example configuration in which a precharge current limitation setting signal is input to the controller 15 in the first embodiment.

FIG. 4 is a timing chart illustrating a precharging operation of one of example controls that are performed by the controller 15 in an ordinary case in the first embodiment.

FIG. 5 shows an example configuration in which an overcurrent limitation value setting signal is input to the controller 15 in the first embodiment when an overcurrent has occurred.

FIG. 6 is a timing chart illustrating an operation, performed upon occurrence of an overcurrent, of one of example controls that are performed by the controller 15 in an abnormal case in the first embodiment.

FIG. 7 shows an example configuration in which an overcurrent limitation value setting signal is input to the controller 15 in the first embodiment when a short circuit has occurred.

FIG. 8 is a timing chart illustrating an operation, performed upon occurrence of a short circuit, of one of example controls that are performed by the controller 15 in an abnormal case in the first embodiment.

FIG. 9 shows an example configuration in which a system abnormality signal or a collision signal is input to the controller 15 in the first embodiment when a system abnormality or a collision has occurred.

FIG. 10 is a timing chart illustrating an operation, performed upon occurrence of a system abnormality or a collision, of one of example controls that are performed by the controller 15 in an abnormal case in the first embodiment.

FIG. 11 is a flowchart illustrating an example process that is executed by the controller 15 in the first embodiment.

FIG. 12 shows an example configuration of the junction box 1A according to a second embodiment of the present disclosure.

FIG. 13 shows an example configuration of a junction box 1B which is suitable for a case that complete insulation is not necessary and in which the number of components is reduced.

FIG. 14 shows an example configuration of a junction box 1C which is suitable for a case that complete insulation is not necessary and in which the number of components is reduced.

### DETAILED DESCRIPTION OF THE EXEMPLARY EMBODIMENTS

### Embodiment 1

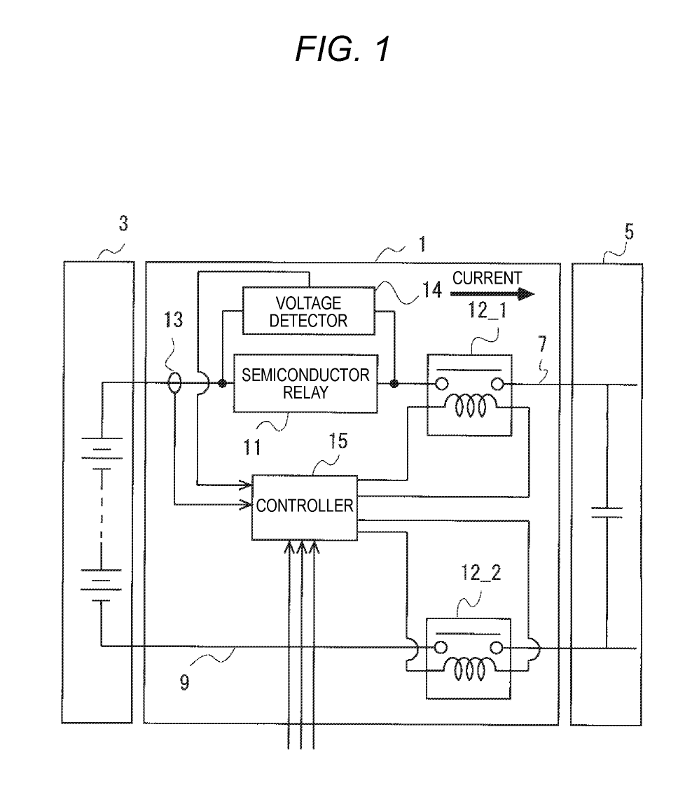

FIG. 1 shows an example configuration of a junction box 1 according to a first embodiment. As shown in FIG. 1, the junction box 1 is disposed between a DC power source 3 and a load 5.

The DC power source 3 is a high-voltage power source and is, for example, a battery assembly that is composed of plural cells and installed in a vehicle. The DC power source 3 is one capable of supplying a stable DC voltage like a primary battery or a secondary battery does. The load is a capacitor, for example.

The junction box 1 has a positive path 7 and a negative path 9 which connect the DC power source 3 and the load 5. The junction box 1 is equipped with a semiconductor relay 11, mechanical relays 12_1 and 12_2, a controller 15, a current detector 13, and a voltage detector 14.

The mechanical relay 12_1 is disposed on the positive side of the DC power source 3, that is, on the positive path 7, and controls the connection state of the positive path 7. The mechanical relay 12_2 is disposed on the negative side of the DC power source 3, that is, on the negative path 9, and controls the connection state of the negative path 9. Each of the mechanical relays 12_1 and 12_2 will be referred to as a mechanical relay 12 when a particular one of them is meant.

The semiconductor relay 11 is connected in series to the mechanical relay 12_1 which is disposed on the positive side of the DC power source 3, and hence can control the connection state of the positive path 7.

The current detector 13 detects a current flowing through the positive path 7, that is, the high-voltage path, and supplies a detection result to the controller 15, whereby the current flowing through the semiconductor relay 11 is detected. The voltage detector 14 detects a voltage across the semiconductor relay 11 and supplies a detection result to the controller 15. Where the semiconductor relay 11 is a MOSFET, its drain-source voltage V_{DS} is detected.

For example, the controller 15, which controls the junction box 1, is configured using a microcomputer as a main component. More specifically, the controller 15 controls driving of the mechanical relays 12 and driving of the semiconductor relay 11. Even more specifically, the controller 15 controls the connection/disconnection of each of the positive path 7 and the negative path 9 which are parts of the supply path of power that is supplied from the DC power source 3 to the load 5 by controlling the mechanical relays 12 and the semiconductor relay 11 on the basis of detection results of the current detector 13 and the voltage detector 14.

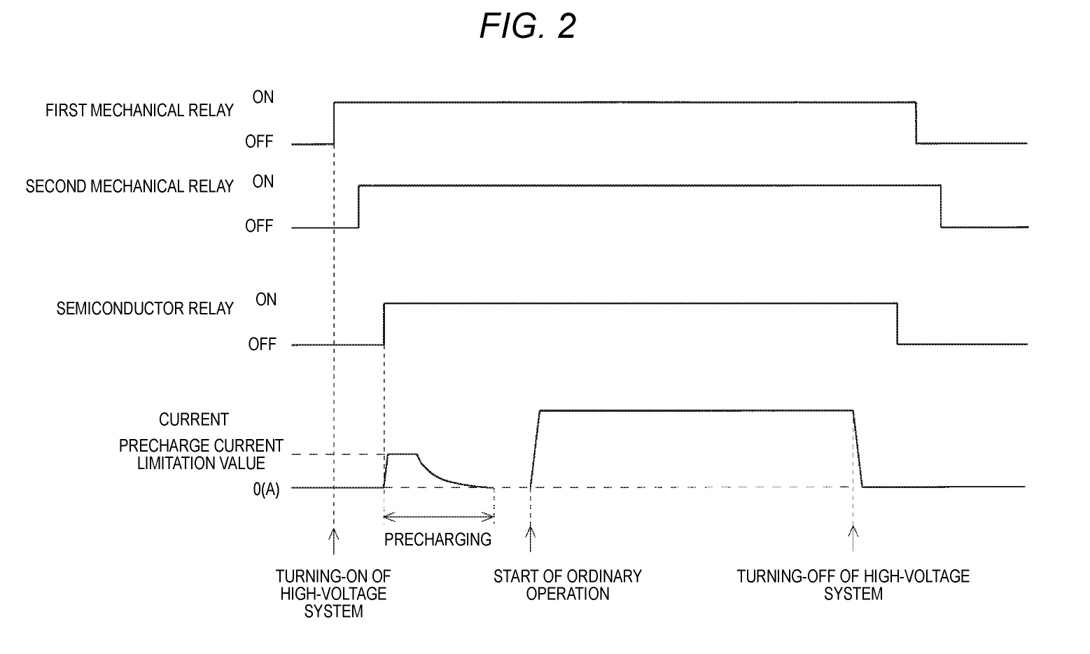

FIG. 2 is a timing chart illustrating an example control that is performed by the controller 15 in an ordinary case in the first embodiment. As shown in FIG. 2, to supply power from the DC power source 3 (high-voltage power source) to the load 5, first, the controller 15 controls the first mechanical relay 12_1 to turn it on. Then the controller 15 controls the second mechanical relay 12_2 to turn it on. Finally, the controller 15 controls the semiconductor relay 11 to turn it on.

On the other hand, to shut off the supply of power from the DC power source 3 to the load 5, first, the controller 15 controls the semiconductor relay 11 to turn it off. Then the controller 15 controls the second mechanical relay 12_2 to turn it off. Finally, the controller 15 controls the first mechanical relay 12_1 to turn it off.

More specifically, when a high-voltage system including the junction box 1 needs to be turned on, that is, when an on-signal is input to the high-voltage system, the controller 15 controls the semiconductor relay 11 to turn it on after controlling the mechanical relays 12_1 and 12_2 to turn them on. Although in FIG. 2 the mechanical relay 12_2 is turned on after turning-on of the mechanical relay 12_1, they may be turned on in the reverse order.

After the turning-on of the semiconductor relay 11, a precharging operation for charging the capacitor of the load 5 is performed in a prescribed period. An ordinary operation is started upon completion of the precharging operation.

On the other hand, the high-voltage system needs to be turned off, that is, when an off-signal is input to the high-voltage system, usually, a transition is made to a state that no high-voltage current flows. After this transition is made, the controller 15 controls the semiconductor relay 11, the mechanical relay 12_2, and the mechanical relay 12_1 to turn them off in this order. Alternatively, as shown in FIG. 2, the controller 15 may control the semiconductor relay 11, the mechanical relay 12_1, and the mechanical relay 12_2 to turn them off in this order.

The above-series of operations prevents generation of an arc at each of the contacts of the mechanical relays 12, whereby the reliability of the contacts of the mechanical relays 12 is increased. Although a leakage current could occur in the semiconductor relay 11 itself in a power shutoff state, actually no leakage current flows through the path because the mechanical relays 12 isolates the DC power source 3 (high-voltage power source) and the load 5 from each other.

That is, no high-voltage current should be flowing when the mechanical relays 12 are turned on or off. Even if a high-voltage current had been flowing, it would be shut off by the semiconductor relay 11 when the mechanical relays 12 are turned on or off. As a result, an event can be prevented that the contact(s) of (either of) the mechanical relays 12 is damaged due to a high-voltage current.

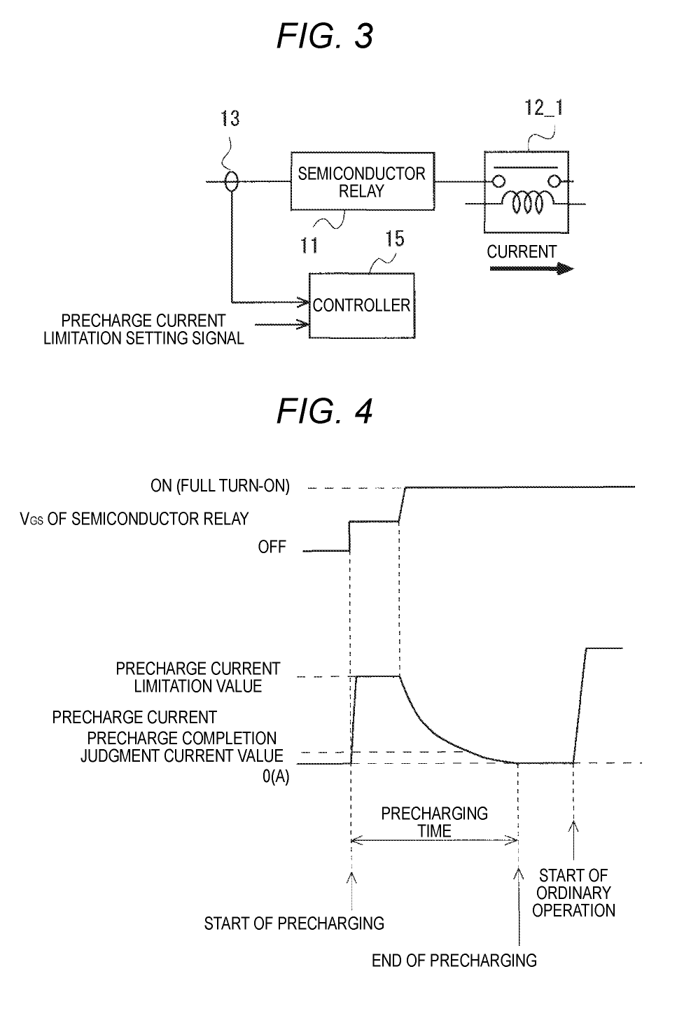

FIG. 3 shows an example configuration in which a precharge current limitation setting signal is input to the controller 15 in the first embodiment. FIG. 4 is a timing chart illustrating a precharging operation of one of example controls that are performed by the controller 15 in an ordinary case in the first embodiment. FIG. 4 shows an example of how the current varies after the precharge current limitation setting signal shown in FIG. 3 is input to the controller 15 and supply of power is started.

As shown in FIG. 4, when the semiconductor relay 11 is turned on, the current flowing through the semiconductor relay 11 is limited to a certain value for a prescribed time by a current limiting function of the semiconductor relay 11. With this control, a precharging function is realized and a rush current can be prevented from flowing through the capacitor of the load 5. Since neither precharge relay nor a precharge resistor is necessary unlike in conventional cases, the overall circuit can be miniaturized and reduced in weight.

More specifically, the precharging operation is performed to prevent a rush current from flowing through the capacitor of the load 5 immediately after turning-on of the semiconductor relay 11. In the precharging operation, the semiconductor relay 11 performs a current limiting operation, that is, the controller 15 adjusts the gate voltage V_{GS} of the semiconductor relay 11 so that the current detected by the current detector 13 becomes equal to a precharge current.

When the capacitor of the load 5 has been charged to a certain extent and the current flowing through the capacitor has become smaller than the current limitation value, the gate voltage V_{GS} of the semiconductor relay 11 is changed to a full-turn-on value. When a prescribed time has elapsed from the end of the precharging operation, that is, the turning-on of the semiconductor relay 11, the high-voltage system makes a transition to an ordinary operation if the current value at this time is smaller than or equal to a precharge completion judgment current value. The precharge current limitation setting is canceled upon the transition to the ordinary operation.

Thus, in the ordinary operation, no current limitation is performed even if a current that is larger than the precharge current set value flows. Since the precharge current set value and the precharge time may vary depending on the car in which the junction box 1 is installed, the junction box 1 is configured so that they can be changed as appropriate.

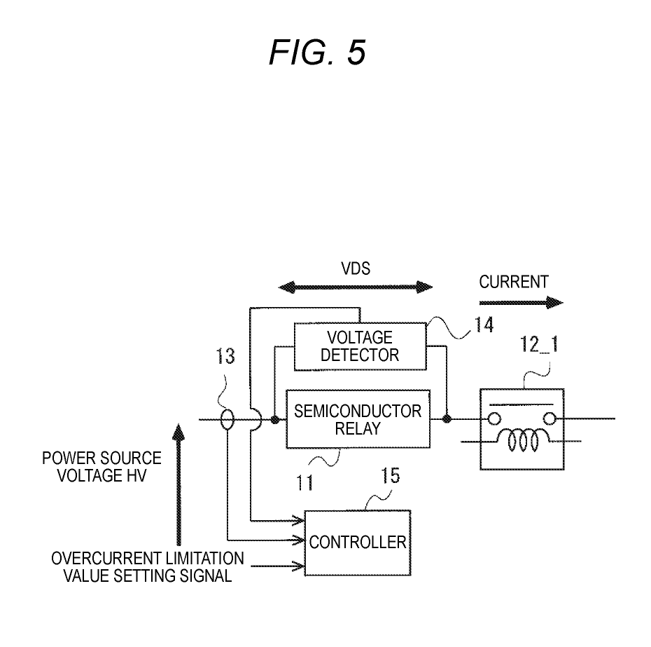

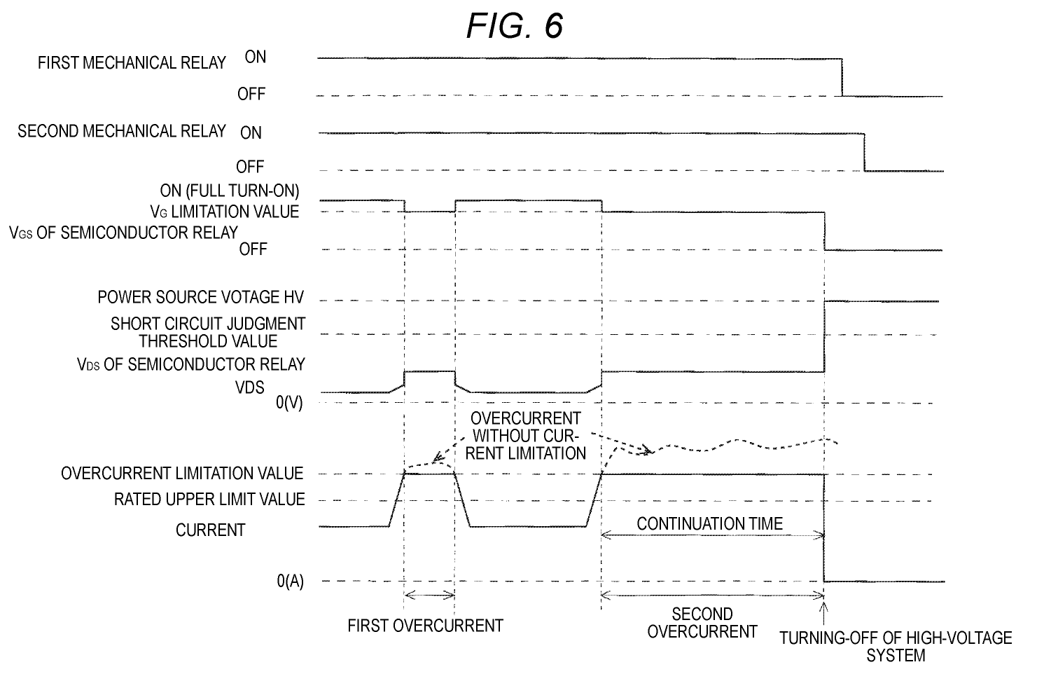

FIG. 5 shows an example configuration in which an overcurrent limitation value setting signal is input to the controller 15 in the first embodiment when an overcurrent has occurred. FIG. 6 is a timing chart illustrating an operation, performed upon occurrence of an overcurrent, of one of example controls that are performed by the controller 15 in an abnormal case in the first embodiment.

FIG. 6 shows an example of how the current varies when an abnormality occurs in a state that a high voltage is being supplied to the load 5. As shown in FIG. 6, if a current that is larger than a steady-state current flows, which means establishment of an overcurrent state, the current is limited to a prescribed value. If the overcurrent state has lasted for a preset continuation time, that is, if the preset continuation time has elapsed in the state that the current is limited to the overcurrent limitation value, the controller 15 judges that the high-voltage system including the junction box 1 has been rendered abnormal and protects the high-voltage system by controlling the semiconductor relay 11 to turn it off.

With this operation, a fuse is no longer necessary and hence the overall circuit can be miniaturized and reduced in weight.

More specifically, if a current that is larger than a rated upper limit value, that is, an overcurrent, occurs during operation of the high-voltage system, the overcurrent is limited to the preset overcurrent limitation value to protect the contacts of the mechanical relays 12, the high-voltage system, and the semiconductor relay 11.

In this case, the drain-source voltage V_{DS} of the semiconductor relay 11 is monitored. If the relationship between the drain-source voltage V_{DS} of the semiconductor relay 11 and the overcurrent limitation value is within a safe operation range of the semiconductor relay 11 as in the case of a first overcurrent shown in FIG. 6, the current limitation operation is continued. An ordinary operation is restored upon cancellation of the overcurrent state.

On the other hand, if overcurrent state has continued for a prescribed time as in the case of a second overcurrent shown in FIG. 6, to protect the semiconductor relay 11, the high-voltage system is isolated from the DC power source 3 by controlling the semiconductor relay 11 to turn it off and then controlling the mechanical relays 12 to turn them off.

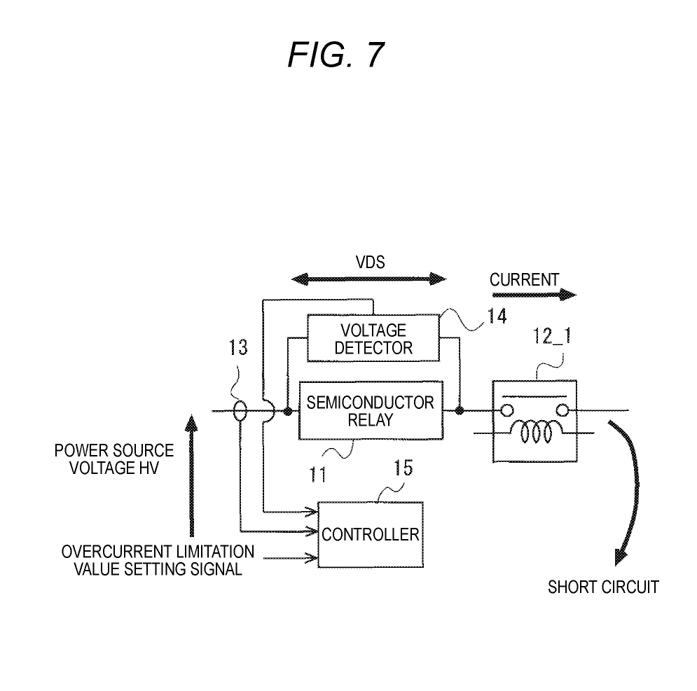

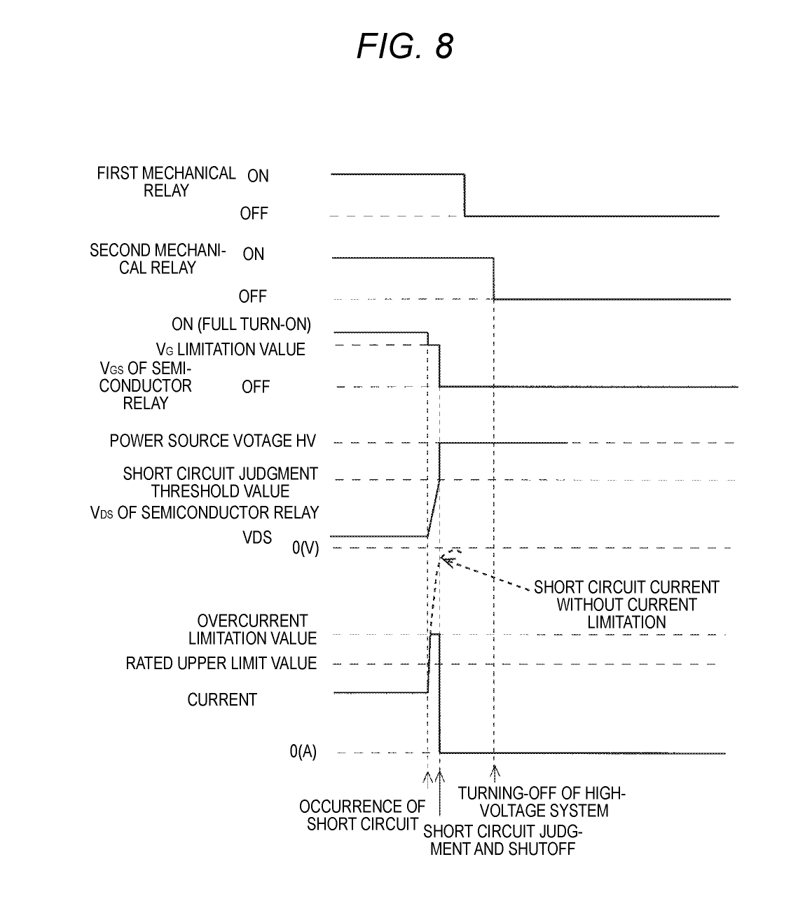

FIG. 7 shows an example configuration in which an overcurrent limitation value setting signal is input to the controller 15 in the first embodiment when a short circuit has occurred. FIG. 8 is a timing chart illustrating an operation, performed upon occurrence of a short circuit, of one of example controls that are performed by the controller 15 in an abnormal case in the first embodiment.

As shown in FIG. 8, even if an overcurrent state has not lasted for the prescribed time, if the voltage across the semiconductor relay 11 exceeds a certain threshold value in the overcurrent state, that is, if the voltage across the semiconductor relay 11 exceeds a preset short circuit judgment threshold value while the current is limited to the overcurrent limitation value, the controller 15 judges that a short circuit has occurred in the high-voltage system including the junction box 1 and protects the high-voltage system by controlling the semiconductor relay 11 to turn it off.

More specifically, when a short circuit occurs during operation of the high-voltage system, the short circuit current is kept at the overcurrent limitation value by an overcurrent limiting function of the semiconductor relay 11. During this current limitation, the internal resistance of the semiconductor relay 11 is used like a variable resistor by adjusting its gate voltage V_{GS}. Thus, the drain-source voltage V_{DS} of the semiconductor relay 11 increases as the short-circuit resistance decreases.

If the drain-source voltage V_{DS} of the semiconductor relay 11 exceeds a prescribed value during the overcurrent limitation, the controller 15 judges that a short circuit has occurred and turns off the semiconductor relay 11. After turning off the semiconductor relay 11, the controller 15 controls the mechanical relays 12 to turn them off and stops the operation of the high-voltage system.

Because of a high power source voltage, usually a short circuit occurring in a high-voltage circuit causes a large short circuit current. In conventional measures against a short circuit that employ a high-voltage fuse and mechanical relays, the contacts of the mechanical relays are formed so as to endure a large current until fusion cutting of the fuse. As a result, the overall circuit has a large size and is costly.

In contrast, in the embodiment, since the semiconductor relay 11 does current limitation, no consideration needs to be made of a short circuit current for the mechanical relays 12 for isolating the high-voltage system from the DC power source 3 physically. This allows selection of mechanical relays 12 just capable of a flow of a rated current.

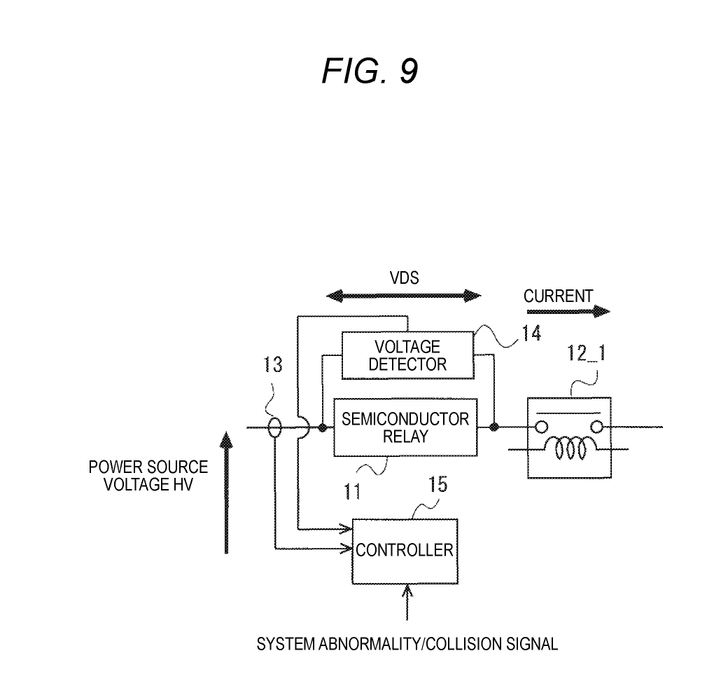

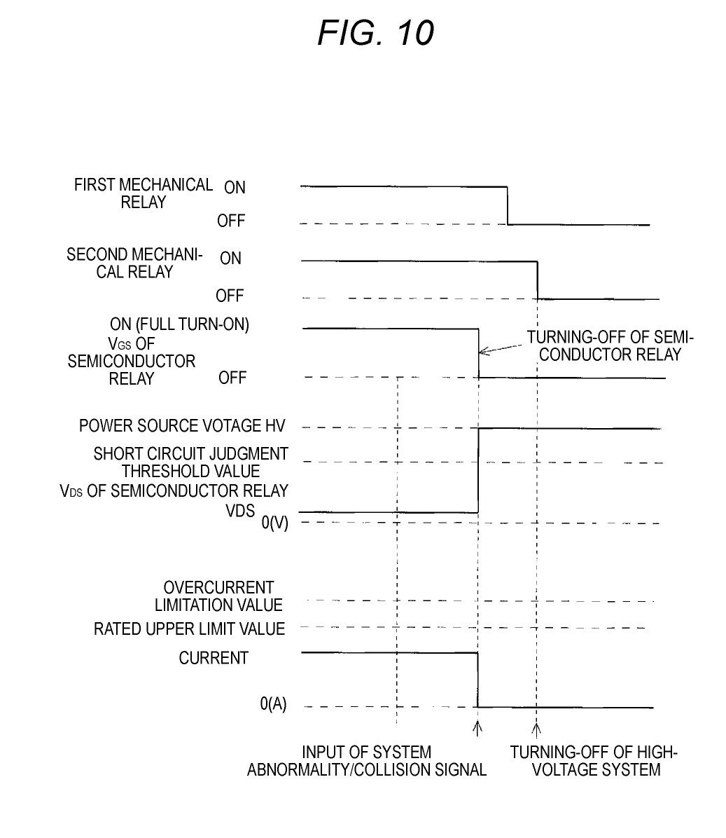

FIG. 9 shows an example configuration in which a system abnormality signal or a collision signal is input to the controller 15 in the first embodiment when a system abnormality or a collision has occurred. FIG. 10 is a timing chart illustrating an operation, performed upon occurrence of a system abnormality or a collision, of one of example controls that are performed by the controller 15 in an abnormal case in the first embodiment.

FIG. 10 shows how the circuit components behave when a power shutoff is performed in response to supply of a system abnormality signal or a collision signal from an outside system. As shown in FIG. 10, the controller 15 shuts off the supply of power from the DC power source 3 by controlling the semiconductor relay 11 to turn it off and then controlling the mechanical relays 12 to turn them off. By turning off the mechanical relays 12 in this manner, reliable insulation from the current detector 13 can be realized.

More specifically, when receiving a signal indicating occurrence of a system abnormality, a collision, or the like in or of the vehicle, to stop the operation of the high-voltage system, first the controller 15 controls the semiconductor relay 11 to turn it off and then controls the mechanical relays 12 to turn them off.

With the above shutoff procedure, a shutoff without arc generation is possible because a high-voltage current flowing is shut off by the semiconductor relay 11. Since the controller 15 turns off the mechanical relays 12 after turning off the semiconductor relay 11, the DC power source 3 (high-voltage power source) can be isolated from the load 5 reliably. As a result, no leakage of electricity occurs and hence post-accident handling etc. can be carried out safely.

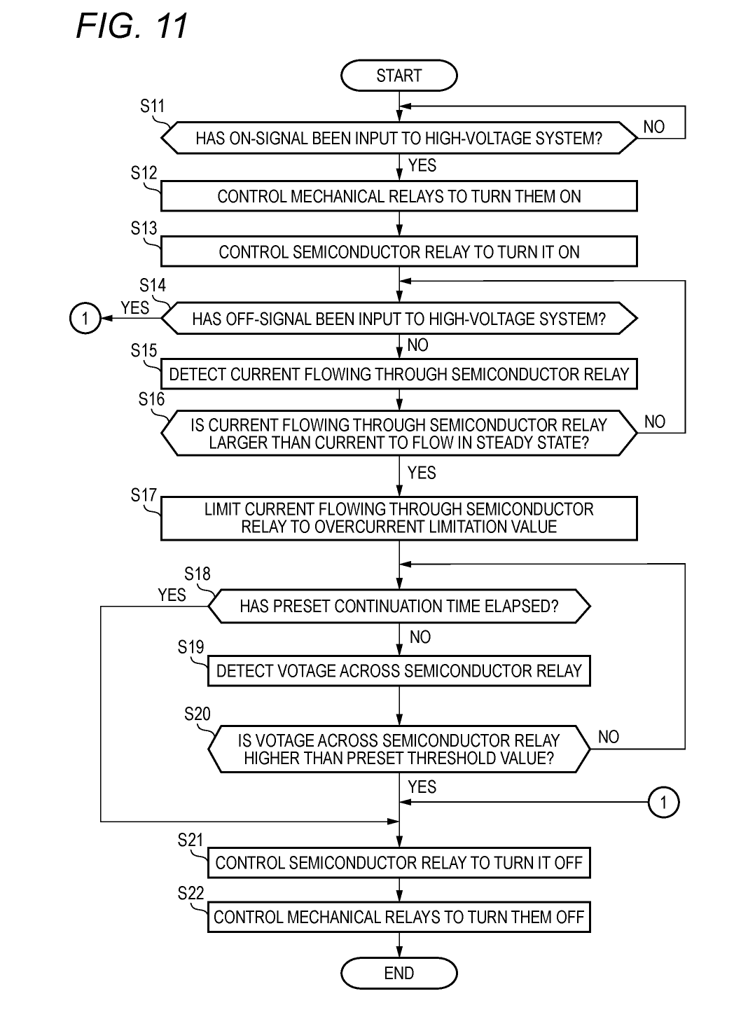

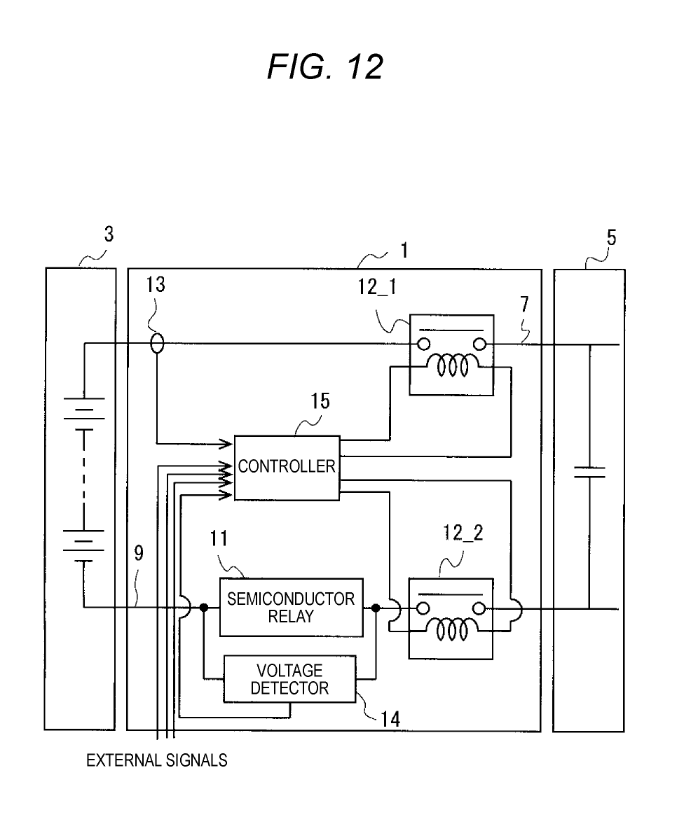

FIG. 11 is a flowchart illustrating an example process that is executed by the controller 15 in the first embodiment.

At step S11, the controller 15 judges whether or not an on-signal has been input to the high-voltage system. If judging that an on-signal has been input to the high-voltage system, the controller 15 moves to step S12. If not, the controller 15 returns to step S11.

At step S12, the controller 15 controls the mechanical relays 12 to turn them on. At step S13, the controller 15 controls the semiconductor relay 11 to turn it on.

At step S14, the controller 15 judges whether or not an off-signal has been input to the high-voltage system. If judging that an off-signal has been input to the high-voltage system, the controller 15 moves to step S21. If not, the controller 15 moves to step S15.

At step S15, the current detector 13 detects a current flowing through the semiconductor relay 11 and supplies a detection signal to the controller 15.

At step S16, the controller 15 judges whether or not the current flowing through the semiconductor relay 11 is larger than a current to flow through it in a steady state. If the current flowing through the semiconductor relay 11 is larger than a current to flow through it in the steady state, the controller 15 moves to step S17. If not, the controller 15 returns to step S14.

At step S17, the controller 15 limits the current flowing through the semiconductor relay 11 to an overcurrent limitation value.

At step S18, the controller 15 judges whether or not a preset continuation time has elapsed. If judging that the preset continuation time has elapsed, the controller 15 moves to step S19. If not, the controller 15 moves to step S21.

At step S19, the voltage detector 14 detects a voltage across the semiconductor relay 11, that is, its drain-source voltage V_{DS}, and supplies a detection result to the controller 15.

At step S20, the controller 15 judges whether or not the voltage across the semiconductor relay 11, that is, its drain-source voltage V_{DS}, is higher than a preset threshold value, that is, a short circuit judgment threshold value. If judging that the drain-source voltage V_{DS} of the semiconductor relay 11 is higher than a preset short circuit judgment threshold value, the controller 15 moves to step S21. If not, the controller 15 returns to step S18.

At step S21, the controller 15 controls the semiconductor relay 11 to turn it off. At step S22, the controller 15 controls the mechanical relays 12 to turn them off. Then, the controller 15 finishes the execution of the process.

As described above, in the junction box 1 according to the first embodiment, the mechanical relays 12 are disposed on the positive side and the negative side of the DC power source 3, respectively, and the semiconductor relay 11 is disposed on the positive side of the DC power source 3.

Since the mechanical relays 12 are disposed on the positive side and the negative side of the DC power source 3, respectively, when the supply of power from the DC power source 3 to the load 5 is shut off, the DC power source 3 and the load 5 are isolated physically. Thus, the mechanical relays 12 can prevent occurrence of a leakage current in the semiconductor relay 11, whereby the junction box 1 can be increased in safety.

Furthermore, when the high-voltage system has been turned on, the controller 15 controls the semiconductor relay 11 to turn it on and then controls the mechanical relays 12 to turn them on. When the high-voltage system has been turned off, the controller 15 controls the semiconductor relay 11 to turn it off and then controls the mechanical relays 12 to turn them off. Since the supply of power is started or shut off using the semiconductor relay 11 which does not cause an arc, the contacts of the mechanical relays 12 can be protected. That is, the mechanical relays 12 can be miniaturized by virtue of the cooperation between the semiconductor relay 11 and the mechanical relays 12.

Since the functions to be realized by a precharge relay and a precharge resistance can be implemented using the current limiting function of the semiconductor relay 11, the circuit components can further be miniaturized and reduced in weight.

Because of the use of the current limiting function of the semiconductor relay 11, no large current flows through the circuit network inside the junction box 1 event at the occurrence of a short circuit. It is therefore not necessary to set a large contact maximum bearable current for the mechanical relays 12, enabling miniaturization of the mechanical relays 12.

Current limitation at the time of an overcurrent and protection from a short circuit can be realized utilizing the internal resistance of the semiconductor relay 11. As a result, a fuse is made unnecessary, which means further miniaturization and weight reduction of the circuit components.

Even at the occurrence of such an abnormality as a collision, the mechanical relays 12 are turned off after turning-off of the semiconductor relay 11. Thus, the DC power source 3 and the load 5 can be isolated from each other physically by the mechanical relays 12, whereby isolation from the high-voltage circuit including the DC power source 3 is enabled. This increases the safety of the junction box 1 further.

Since the devices having a shutoff function, that is, the semiconductor relay 11 and the mechanical relay 12_1 are provided in series, supply of power and power shutoff can be realized even if one of the semiconductor relay 11 and the mechanical relay 12_1 suffers an on-sticking failure. A redundant circuit is thus obtained to increase the safety further.

In other words, in the junction box 1, the semiconductor relay 11 and the mechanical relay 12_1 are connected to each other in series and the mechanical relays 12 are turned off after turning-off of the semiconductor relay 11 at the occurrence of an abnormal state. Thus, the semiconductor relay 11 can limit an overcurrent and the mechanical relays 12 enable physical isolation from the high-voltage circuit. As a result, the junction box 1 can be increased in safety while it is miniaturized and reduced in weight.

When the current flowing through the semiconductor relay 11 is larger than a steady-state current, it is limited to the overcurrent limitation value. Thus, a fuse is made unnecessary, which means further miniaturization and weight reduction of the overall circuit.

The mechanical relays 12 are turned off after turning-off of the semiconductor relay 11 in each of a case that overcurrent limitation is being made, a case that the continuation time has elapsed, and a case that the drain-source voltage V_{DS} of the semiconductor relay 11 has exceeded the short circuit judgment threshold value. As a result, no large current flows through the mechanical relays 12 and hence the contact maximum bearable current can be reduced.

In starting to supply power from the DC power source 3 to the load 5, the semiconductor relay 11 is turned on after turning-on of the mechanical relays 12. This enables a precharging operation that utilizes the current limiting function of the semiconductor relay 11. As a result, neither a precharge relay nor a precharge resistor is necessary to perform a precharging operation, whereby the overall circuit can be miniaturized and reduced in weight.

### Embodiment 2

A junction box 1A according to a second embodiment is the same as the junction box 1 according to the first embodiment in the arrangement of the mechanical relays 12 and the manner of cooperation between the semiconductor relay 11 and the mechanical relays 12, and descriptions therefor will be omitted. On the other hand, the junction box 1A according to the second embodiment is different from the junction box 1 according to the first embodiment in the disposition of the semiconductor relay 11, which will be described below in detail.

FIG. 12 shows an example configuration of the junction box 1A according to the second embodiment. As shown in FIG. 12, the semiconductor relay 11 is connected in series to the mechanical relay 12_2 which is disposed on the negative side of the DC power source 3.

With this configuration, even if the high-voltage system is rendered in an abnormal state, by controlling the mechanical relays 12 to turn them off after controlling the semiconductor relay 11 to turn it off, an overcurrent flowing through the semiconductor relay 11 can be limited and the mechanical relays 12 enable physical isolation from the high-voltage circuit. As a result, the junction box 1A can be increased in safety while it is miniaturized and reduced in weight.

As described above, the junction box 1A according to the second embodiment is disposed between the DC power source 3 and the load 5, and is equipped with the mechanical relays 12_1 and 12_2 disposed on the positive side and the negative side of the DC power source, respectively, the semiconductor relay 11 which is connected in series to the mechanical relay 12_2 disposed on the negative side of the DC power source 3, and the controller 15 which controls driving of the mechanical relays 12_1 and 12_2 and driving of the semiconductor relay 11. When an abnormal state has occurred, the controller 15 controls the mechanical relays 12_1 and 12_2 to turn them off after controlling the semiconductor relay 11 to turn it off.

With this configuration, the junction box 1A can be increased in safety while it is miniaturized and reduced in weight.

As described above, the junction box 1 according to the first embodiment or the junction box 1A according to the second embodiment is disposed between the DC power source 3 and the load 5, and is equipped with the mechanical relays 12_1 and 12_2 disposed on the positive side and the negative side of the DC power source, respectively, the semiconductor relay 11 which is connected in series to at least one of the mechanical relay 12_1 disposed on the positive side of the DC power source 3 and the mechanical relay 12_2 disposed on the negative side of the DC power source 3, and a controller 15 which controls driving of the mechanical relays 12_1 and 12_2 and driving of the semiconductor relay 11. When an abnormal state has occurred, the controller 15 controls the mechanical relays 12_1 and 12_2 to turn them off after controlling the semiconductor relay 11 to turn it off.

With this configuration, the junction box 1 or 1A can be increased in safety while it is miniaturized and reduced in weight.

In the junction box 1 or 1A according to each embodiment, if the abnormal state is that a current that is larger than a steady-state current is flowing through the semiconductor relay 11, the controller 15 limits the current flowing through the semiconductor relay 11 to an overcurrent limitation value.

With this configuration, the overall circuit of the junction box 1 or 1A can be miniaturized and reduced in weight.

In the junction box 1 or 1A according to each embodiment, a preset continuation time has elapsed or a voltage across the semiconductor relay 11 has become higher than a preset short circuit judgment threshold value in a state that the current flowing through the semiconductor relay 11 is limited to the overcurrent limitation value, the controller 15 controls the mechanical relays 12 to turn them off after controlling the semiconductor relay 11 to turn it off.

With this configuration, in the junction box 1 or 1A, the contact maximum bearable current of the mechanical relays 12 can be reduced.

In the junction box 1 or 1A according to each embodiment, in starting supply of power from the DC power source 3 to the load 5, the controller 15 controls the semiconductor relay to turn it on after controlling the mechanical relays 12 to turn them on.

With this configuration, in the junction box 1 or 1A, neither a precharge relay nor a precharge resistor is necessary to perform a precharging operation, whereby the overall circuit can be miniaturized and reduced in weight.

Although the present disclosure has been described above in the form of the first and second embodiments, the present disclosure is not limited to these embodiments and various modifications are possible without departing from the spirit and scope of the present disclosure.

For example, although in the first and second embodiments the load 5 is a capacitor, the present disclosure is not limited this case: the load 5 may have a circuit configuration including plural switching elements.

Although in the first and second embodiments the semiconductor relay 11 is, for example, a MOSFET, in the present disclosure it suffices that the semiconductor relay 11 be a semiconductor switching elements whose internal resistance is adjustable.

Although the first and second embodiments employ the mechanical relays 12 as circuit components to cooperate with the semiconductor relay 11, the present disclosure is not limited to this case: it suffices that the circuit components to cooperate with the semiconductor relay 11 be ones capable of isolating the junction box 1 or 1A physically from the DC power source 3.

Although the junction box 1 or 1A according to each embodiment is configured so as to be suitable for the case that complete insulation is necessary, the present disclosure is not limited to this case. Where complete insulation is not necessary, junction boxes are possible that are configured differently from the junction box 1 or 1A.

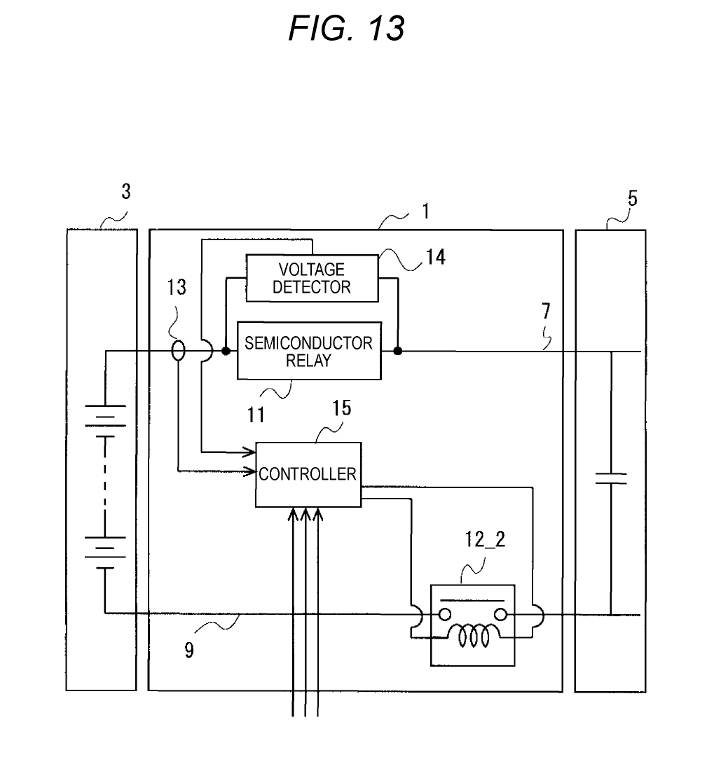

For example, FIG. 13 shows a junction box 1B which is suitable for the case that complete insulation is not necessary and in which the number of components is reduced. As shown in FIG. 13, a circuit network is formed in which a current circulates so as to pass the DC power source 3, the semiconductor relay 11, the load 5, the mechanical relay 12_2, and the DC power source 3 in this order. The semiconductor relay 11 and the mechanical relay 12_2 are connected to each other in series via the load 5. Thus, even if one of the semiconductor relay 11 and the mechanical relay 12_2 suffers an on-sticking failure, the other can perform a control to establish an on state or an off state. Miniaturization and weight reduction can therefore be attained.

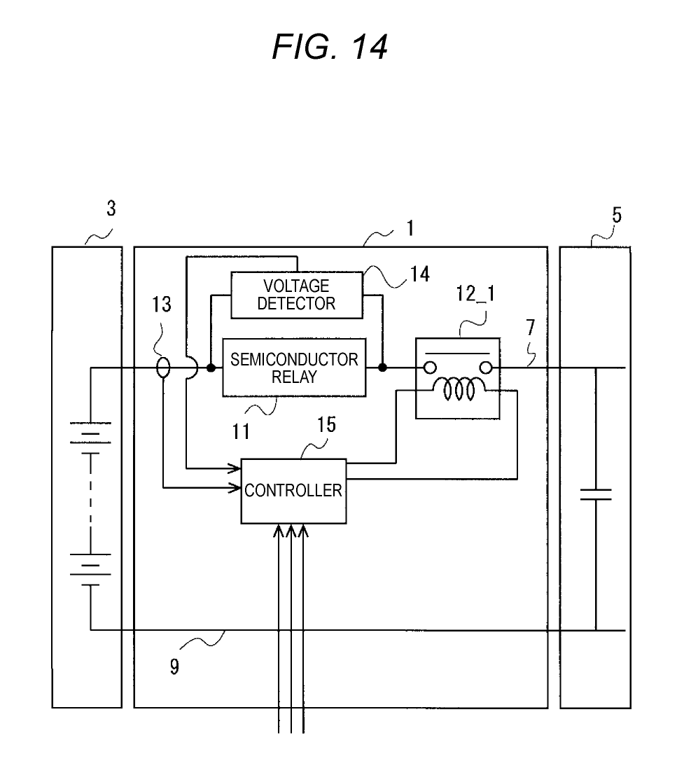

For another example, FIG. 14 shows a junction box 1C which is suitable for the case that complete insulation is not necessary and in which the number of components is reduced. As shown in FIG. 14, a circuit network is formed in which a current circulates so as to pass the DC power source 3, the semiconductor relay 11, the mechanical relay 12_1, the load 5, and the DC power source 3 in this order. The semiconductor relay 11 and the mechanical relay 12_1 are connected to each other in series. Thus, even if one of the semiconductor relay 11 and the mechanical relay 12_1 suffers an on-sticking failure, the other can perform a control to establish an on state or an off state. Miniaturization and weight reduction can therefore be attained.

Here, the details of the above embodiments are summarized as follows.

The present disclosure provides a junction box configured to be arranged between a DC power source and a load, the junction box including: a first mechanical relay configured to be connected to a positive terminal of the DC power source; a second mechanical relay configured to be connected to a negative terminal of the DC power source; a semiconductor relay connected in series to at least one of the first mechanical relay and the second mechanical relay; and a controller that controls driving of the first mechanical relay, the second mechanical relay and the semiconductor relay respectively, wherein when an abnormal state occurs, the controller controls the first and second mechanical relays to turn the first and second mechanical relays off after controlling the semiconductor relay to turn the semiconductor relay off.

With this configuration, the junction box according to the present disclosure can be increased in safety while it is miniaturized and reduced in weight.

In the junction box according to the present disclosure, if the abnormal state is that a current larger than a steady-state current flows through the semiconductor relay, the controller limits the current flowing through the semiconductor relay to an overcurrent limitation value being smaller than the steady-state current.

With this configuration, the overall circuit of the junction box can be miniaturized and reduced in weight.

In the junction box according to the present disclosure, when a predetermined continuation time elapses or a voltage across the semiconductor relay becomes higher than a short circuit judgment threshold value in a state that the current flowing through the semiconductor relay is limited to the overcurrent limitation value, the controller controls the first and second mechanical relays to turn the first and second mechanical relays off after controlling the semiconductor relay to turn the semiconductor relay off.

In the junction box having this configuration, the contact maximum bearable current of the first and second mechanical relays can be reduced.

In the junction box according to the present disclosure, when supply of power from the DC power source to the load is started, the controller controls the semiconductor relay to turn the semiconductor relay on after controlling the first and second mechanical relays to turn the first and second mechanical relays on.

In the junction box having this configuration, neither a precharge relay nor a precharge resistor is necessary to perform a precharging operation, whereby the overall circuit can be miniaturized and reduced in weight.

What is claimed is:

1. A junction box configured to be arranged between a DC power source and a load, the junction box comprising:
a first mechanical relay configured to be connected to a positive terminal of the DC power source;
a second mechanical relay configured to be connected to a negative terminal of the DC power source;
a semiconductor relay connected in series to at least one of the first mechanical relay and the second mechanical relay; and
a controller that controls driving of the first mechanical relay, the second mechanical relay and the semiconductor relay respectively,
wherein when an abnormal state occurs, the controller controls the first and second mechanical relays to turn the first and second mechanical relays off after controlling the semiconductor relay to turn the semiconductor relay off.

2. The junction box according to claim 1, wherein if the abnormal state is that a current larger than a steady-state current flows through the semiconductor relay, the controller limits the current flowing through the semiconductor relay to an overcurrent limitation value being smaller than the steady-state current.

3. The junction box according to claim 2, wherein when a predetermined continuation time elapses or a voltage across the semiconductor relay becomes higher than a short circuit judgment threshold value in a state that the current flowing through the semiconductor relay is limited to the overcurrent limitation value, the controller controls the first and second mechanical relays to turn the first and second mechanical relays off after controlling the semiconductor relay to turn the semiconductor relay off.

4. The junction box according to claim 2, wherein when supply of power from the DC power source to the load is started, the controller controls the semiconductor relay to turn the semiconductor relay on after controlling the first and second mechanical relays to turn the first and second mechanical relays on.
